(19) United States
(12) Patent Application Publication
(10) Pub. No.: US 2005/0199456 A1
(43) Pub. Date: Sep. 15, 2005

(54) Fluidic dampening device

(76) Inventor: Ralph S. Norman, Chula Vista, CA (US)

Correspondence Address: Thompson E. Fehr;Suite 300, Goldenwest Corporate Center, 5025 Adams Avenue, Ogden, UT, 84403, US

(21) Appl. No.: 10/801,626

(22) Filed: Mar. 15, 2004

(51) Int. Cl. F16F 9/14

(52) U.S. Cl. 188/310

(57) ABSTRACT

An improved fluidic dampening device having a first clamp attached to the housing of a fluidic dampening device near the left side of such housing and a second clamp attached to such housing near the right side of the housing so as to create apertures for accommodating handlebars. Each upper segment is releasably connected to each respective lower segment, although a first end of each upper segment may be rotatably connected to each respective lower segment while a second end of each upper segment is releasably connected to each respective lower segment. Preferably, the lower segments are attached to the top of a triple clamp.

### BACKGROUND OF THE INVENTION

1. Field of the Invention

This invention relates to a device that uses a fluid to dampen a force that tends to move the plane of rotation of a steerable wheel or wheels of a vehicle having a shaft used to steer such wheel or wheels away from being generally parallel to the frame of such vehicle. It also relates to any steering device, such as a ski of a snowmobile or the exhaust jet of a personal watercraft, that uses a shaft or the like in the steering process.

2. Description of the Related Art

Dampening devices of the type subject to the present invention are those which contain a rotatable wiper in a housing having a channel running from the a portion of the housing on a first side of the wiper to a portion of the housing on a second side of the wiper so that when the housing is filled with fluid, as the wiper is moved, it forces fluid through the channel.

Examples of such devices are those of U.S. Pat. No. 4,773,514 and U.S. patent application Ser. No. 10/166,498.

Although a dissimilar type of dampener seems to be shown in U.S. Pat. No. 5,516,133 as being below a portion of the handlebars of a bicycle, the present inventor is unaware of any dampener of the type with the rotatable wiper and housing with a channel that is mounted below the handlebars.

### BRIEF SUMMARY OF THE INVENTION

The present Improved Fluidic Dampening Device has a first clamp near a first side of a housing containing a wiper and a channel for transferring fluid from a first side of the wiper to a second side of the wiper as well as a second clamp near a second side of the housing.

Each clamp has an upper section which is releasably fastenable to the handlebars of a vehicle. Thus, the housing is suspended below the handlebars, decreasing the likelihood of the face of a rider striking the housing when the vehicle is jarred.

Preferably, the clamps can also be attached to the top of a triple clamp, which is a device with two deformable apertures that can be squeezed together with a bolt to hold the triple clamp to each of the forks going down on opposite sides of the wheel of a mortorcycles and with a third aperture to accommodate the post about which the forks rotate in order to turn the front wheel of the motorcycles.

### BRIEF DESCRIPTION OF THE SEVERAL VIEWS OF THE DRAWING

FIG. 1 provides a lateral view from the rear of the Improved Fluidic Dampening Device.

FIG. 2 shows a front view of the Improved Fluidic Dampening Device.

FIG. 3 is a lateral view from the left side of the Improved Fluidic Dampening Device.

FIG. 4 is a lateral view from the right side of the Improved Fluidic Dampening Device.

FIG. 5 is a plan view from above the Improved Fluidic Dampening Device.

FIG. 6 shows the bottom of the Improved Fluidic Dampening Device.

FIG. 7 illustrates the Improved Fluidic Dampening Device attached to a triple clamp.

### DETAILED DESCRIPTION OF THE INVENTION

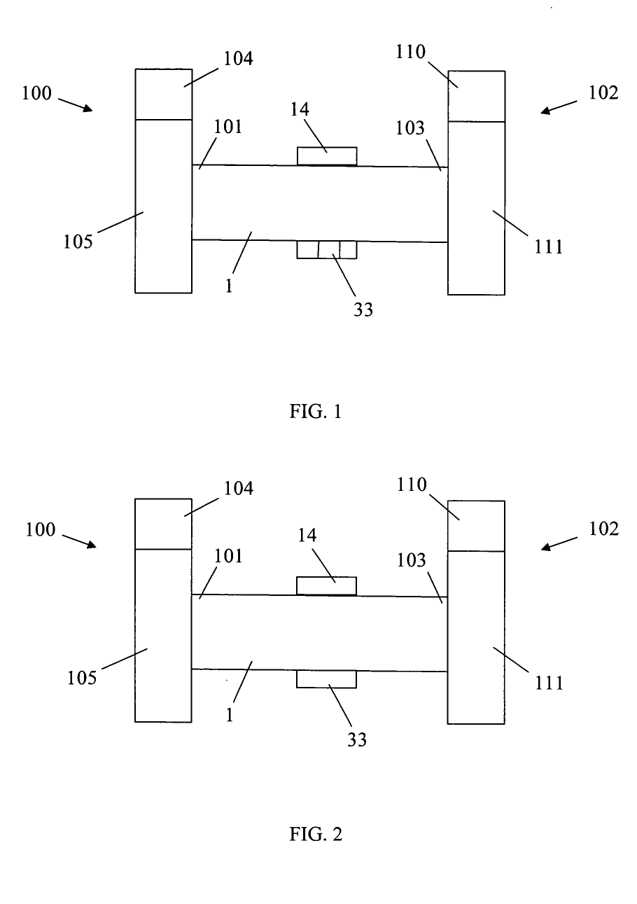

The present Improved Fluidic Dampening Device has, as seen in FIG. 1 and FIG. 2, a first clamp 100 attached near the left side 101 of a housing 1 containing a bypass channel 9 having a first port 10 in a first side wall 3 and a second port 11 in the second side wall 4. A wiper 7 is rotatably mounted between the side wall 3, 4.

More fully to describe an illustrative example of the type of dampening device supported by the clamp 100, U.S. patent application Ser. No. 10/166,498 is hereby incorporated by reference.

A second clamp 102 is, as seen in FIG. 1 and FIG. 2, attached near the right side 103 of the housing 1.

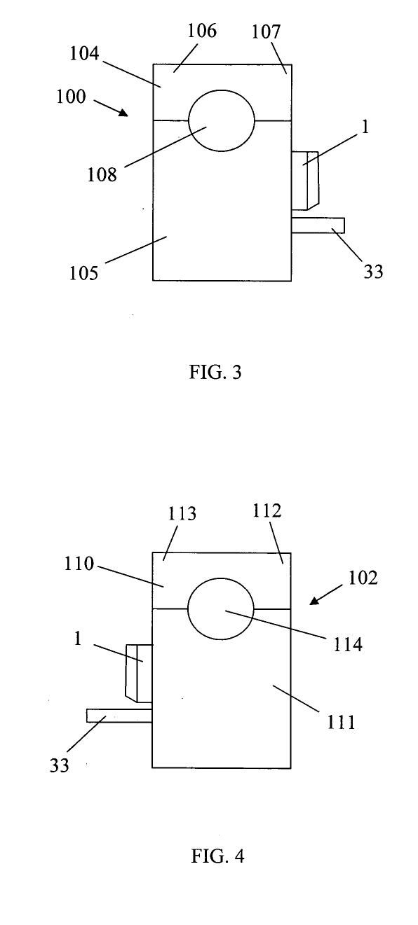

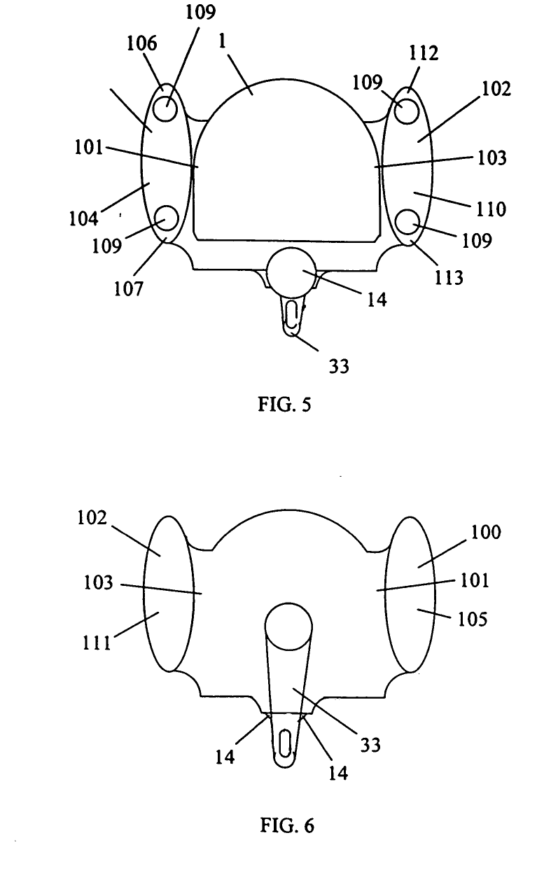

An upper segment 104 of the first clamp 100, seen in FIG. 3, is releasably attached to a lower segment 105 of the first clamp 100, although a first end 106 of the upper segment 104 can be rotatably attached to the lower segment 105 while a second end 107 of the upper segment 104 is releasably attached to the lower segment 105, so as to create an aperture 108 to accommodate handlebars. Releasable attachment is preferably accomplished with one or more screws 109.

Similarly, an upper segment 110 of the second clamp 102, seen in FIG. 4, is releasably attached to a lower segment 111 of the second clamp 102, although a first end 112 of the upper segment 110 can be rotatably attached to the lower segment 111 while a second end 113 of the upper segment 110 is releasably attached to the lower segment 111, so as to create an aperture 114 to accommodate handlebars.

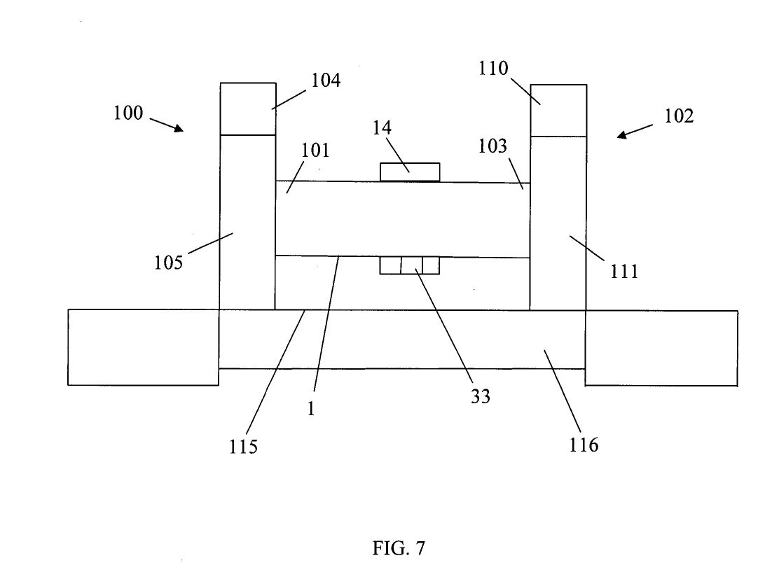

Preferably, the lower segments 105, 111 are releasably attached to the top 115 of a triple clamp 116, as illustrated in FIG. 7, for added support.

As used herein the term “preferable” or “preferably” means that a specified element or technique is more acceptable than another but not that such specified element or technique is a necessity.

1. An improved fluidic dampening device of the type having a housing containing a wiper and a channel for transferring fluid from a first side of the wiper to a second side of the wiper, wherein the improvement comprises:
a first clamp having an upper segment and a lower segment with the upper segment releasably connected to the lower segment so as to create an aperture, said first clamp being attached to the housing near a left side of the housing; and
a second clamp having an upper segment and a lower segment with the upper segment releasably connected to the lower segment so as to create an aperture, said second clamp being attached to the housing near a left side of the housing.

2. The improved fluidic dampening device as recited in claim 1, further comprising:
a triple clamp having a top, with the top of the triple clamp being attached to the lower segment of said first clamp and to the lower segment of said second clamp.

3. An improved fluidic dampening device of the type having a housing containing a wiper and a channel for transferring fluid from a first side of the wiper to a second side of the wiper, wherein the improvement comprises:
a first clamp having an upper segment and a lower segment with a first end of the upper segment rotatably connected to the lower segment and with a second end of the upper segment releasably connected to the lower segment so as to create an aperture, said first clamp being attached to the housing near a left side of the housing; and
a second clamp having an upper segment and a lower segment with a first end of the upper segment rotatably connected to the lower segment and with a second end of the upper segment releasably connected to the lower segment so as to create an aperture, said second clamp being attached to the housing near a left side of the housing.

4. The improved fluidic dampening device as recited in claim 3, further comprising:
a triple clamp having a top, with the top of the triple clamp being attached to the lower segment of said first clamp and to the lower segment of said second clamp.
